(19) United States
(12) Patent Application Publication
(10) Pub. No.: US 2008/0282931 A1
(43) Pub. Date: Nov. 20, 2008

(54) Pigment Compositions for Oil-Based Lithographic Printing Ink System

(76) Inventors: Stuart Cook Niven, Ayrshire (GB); Joyce Wilcox, Renfrewshire (GB); Stephen Haggata, North Lanarkshire (GB)

Correspondence Address: JoAnn Villamizar;Ciba Corporation/Patent Department, 540 White Plains Road, P.O. Box 2005, Tarrytown, NY, 10591, US

(21) Appl. No.: 10/577,975

(22) PCT Filed: Nov. 1, 2004
(86) PCT No.: PCT/EP04/52741

§ 371 Date: May 2, 2006

(30) Foreign Application Priority Data
Nov. 11, 2003 (EP) 03104151.0

(51) Int. Cl. C09D 7/12; B41F 1/18; C09D 11/02; C09D 11/10; C09B 67/08

(52) U.S. Cl. 106/31.28; 106/400; 106/493; 106/496; 101/450.1; 106/31.65; 524/601

(57) ABSTRACT

Pigment compositions for oil-based lithographic printing ink systems are provided which comprise as colourant besides an organic pigment an organic dyestuff soluble in an organic solvent (solvent dye). The printing inks prepared from these pigment compositions show outstanding improvements in colour strength combined with improvements in both gloss and transparency of the prints obtained.

The present invention relates to pigment compositions suitable for use in oil-based lithographic printing inks. More particularly, the invention relates to pigment compositions containing a combination of a pigment and an organic dyestuff soluble in an organic solvent (solvent dye).

Lithographic printing is a process which utilizes a coated metal or polymeric plate containing a hydrophobic image area which accepts hydrophobic based ink and a non-image hydrophilic area which accepts water, i.e. the fount(ain) solution.

Traditional pigment-based inks for off-set lithographic printing require as a rule an increased level of pigmentation in order to achieve higher colour strength. Increases in pigment loading result, however, in both manufacturing and performance problems. A high pigment loading may cause various difficulties, such as a reduced dispersibility of the pigment resulting in oversize pigment partides and grit, or a small wetting performance of the pigment. Poor wetting and dispersion lead, on the other hand, to poor colour strength, and further, increased shear rate is required during the manufacture of the inks to achieve the desired dispersion and to overcome the viscosity. Other problems that derive from high pigment loadings and/or high viscosity of the inks may be poor transfer and distribution on the printing press rollers, and a considerable reduction of the film-forming properties of the printing inks. And finally, high pigment loaded inks may lead to prints of poor transparency and gloss.

An alternative approach to increased colour strength would be to increase the thickness of the ink film though this results in further problems. Increased film thickness can result in prints that are more difficult to dry or cure, further a lower transparency and a reduced printed image definition can be observed. Another problem that can be caused by an increased ink film thickness is the achievement of a correct ink/water balance on lithographic presses thus leading to printability problems. And also, increased ink film thickness results in greater expense in that shorter press runs are possible only and more frequent ink supply changes needed.

It has now been found that these problems can be overcome and outstanding effects with regard to e.g. increased colour strength, but also improved gloss and transparency of the prints obtained, and improved printing performance, can be achieved when using the new organic pigment/solvent dye compositions, hereinafter described, in lithographic printing ink systems.

Lithographic printing ink based purely on solvent dyes can be prepared but these do not show any strength advantage over pigment based inks.

Accordingly it is the main object of the present invention to provide said new pigment/solvent dye compositions. Other objects of the present invention relate to processes to prepare said compositions, to prepare printing inks from said compositions, the thus obtained printing inks, and the use of said inks in lithographic printing processes. These and other objects of the present invention will be described in the following.

Therefore, in a first aspect of the present invention, there is provided a (pigment) composition comprising an organic pigment and an organic dyestuff soluble in an organic solvent (solvent dye).

This particular combination of an organic pigment and a solvent dye—when incorporated in a printing ink for lithographic printing systems - results in an ink which displays e.g. higher colour strength and printing performance.

The pigments are those producing the four colours commonly used in the printing industry: namely black, cyan (blue), magenta (red) and yellow. As a rule, they are compatible with the other components of the inventive ink compositions and constitute the basis (colourant) for forming the oil-based printing inks for lithographic printing processes, which are another object of the present invention.

Organic pigments comprise such as, but not exclusively, monoazo, disazo, azomethin, azocondensation, metal-complex azo, naphthol, metal complexes, such as phthalocyanines, dioxazone, nitro, perinone, quinoline, anthraquinone, hydroxyanthraquinone, aminoanthraquinone, benzimidazolone, isoindoline, isoindolinone, quinacridone, anthrapyrimidine, indanthrone, flavanthrone, pyranthrone, anthanthrone, isoviolanthrone, diketopyrrolopyrrole, carbazole, perylene, indigo or thioindigo pigments. Mixtures of the pigments may also be used.

The disazo pigments represent an important class of colouring materials (colourants) used commonly for the manufacture of lithographic printing inks. Preferably they are yellow and orange diarylide pigments and orange disazopyrazolone pigments, including e.g. the C.I. (Colour Index) Pigment Yellows 12, 13, 14, 17, 83, 174, and 188, as well as the C.I. Pigment Oranges 13 and 34 which are often used as shading agents. Preferred blue pigments are e.g. metal complexes, such as copper phthalocyanine pigments (e.g. C.I. Pigment Blue 15:3), while the red pigments are e.g. the naphthol pigments, preferably β-naphthol or β-oxynaphthoic acid (BONA) pigments (e.g. C.I. Pigment Red 57:1).

For further details as to all these organic pigments reference is made to Industrial Organic Pigments, W. Herbst, K. Hunger, 2^{nd} edition, VCH Verlagsgesellschaft, Weinheim, 1997.

The pigments can carry surface treatments in order to improve their performance within the chosen ink system. Typical additives for surface treatment are, for example but not exclusively, the rosin acids, ionic or nonionic surfactants and ionic dyestuffs. The appropriate selection of pigment additives and those for surface treatments suitable for the chosen ink system can be carried out by one skilled in the art.

“Solvent Dye” is a term well known in the art and defined in the Colour Index (C.I.), published by the Society of Dyers and Colourists and the American Association of Textile Chemists and Colorists.

As to the chemical constitution of the solvent dyes the monoazo and disazo, and also some polyazo dyes predominate. Other important dyes are xanthene, triarylmethane, anthra-quinone, azine, thiazine and phthalocyanine dyes.

Representative red dyes include the C.I. Solvent Reds 19, 23, 24, 25, 26, 27 and 29 (which all are disazo dyes), further the C.I. Solvent Reds 1, 49, 52, and 111.

Representative blue dyes include the C.I. Solvent Blues 14, 35, 36, 59, and 78.

Representative yellow dyes include the C.I. Solvent Yellows 7, 14, 33, 72, 94, and 114.

Representative orange dyes include the C.I. Solvent Oranges 1, 2, and 7.

The pigment/solvent dye ratios comprise as a rule (99-1): (1-99), preferably (98-10): (2-90) and most preferred (95-30): (5-70). Within this last range, the ratio of (95-65): (5-35) is of special interest.

The inventive printing ink preparations (printing inks) may contain 0.1 to 70% by weight (all percentages mentioned below are by weight) of the inventive pigment/solvent dye composition, the remainder being customary printing ink-varnishes (ink-vehicles), solvents and other suitable and well known additives. The 0.1 to 70% range covers concentrated and ready-to-use printing inks. For actual use, the concentrated printing inks are diluted with suitable solvents, resins, varnishes (ink vehicles) or varnish/ink vehicle components.

Preferred are percentages of said pigment/solvent dye compositions of 2 to 55%, preferably of 2 to 20%; for normal preparation methods (printing inks ready for use) the range of 12 to 18% is of special interest, while the 20 to 70%, preferably 20 to 55%, range is for concentrate production.

Within this preference range of 20 to 55%, concentrate production by bead-mill is preferably carried out with said compositions of 20 to 35% pigment/solvent dye content; whereas for a production by kneader the corresponding preferred range is 35 to 55%. These concentrates, which can also be prepared at various concentrations by extrusion, can be the basis for preparing the inks, e.g. by dilution, used for the actual printing process.

Another embodiment of the inventive organic pigment/solvent dye compositions could be considered as surface treated (coated) pigment compositions which comprise (highly concentrated) organic pigment/solvent dye combinations, for example containing about 70 to 90% of said combination, and about 30 to 10% of printing ink-varnishes, solvents and other suitable additives mentioned hereinbelow.

They may be prepared by surface treating (coating) the organic pigment with a varnish (ink vehicle) or varnish component, solvent and other additives, such as resin acids, the vehicle(s) (components) or additives being mixed or coloured with the solvent dye either prior or during processing. The solvent dye may be present in dispersed or dissolved form.

More particularly, the process for preparing these (surface treated and concentrated) pigment compositions comprises
(a) incorporating the printing ink varnish, which is premixed or coloured with the solvent dye, into a aqueous slurry of the organic pigment, isolating, and optionally drying it, or
(b) adding the printing ink varnish to an aqueous slurry of the solvent dye and then combining it with an aqueous slurry of the organic pigment, isolating, and optionally drying it, or
(c) adding the printing ink varnish to an aqueous slurry of a solvent dye/organic pigment combination, isolating, and optionally drying it.

Printing inks for the actual printing process can be obtained e.g. by diluting the concentrates. The printing ink-varnishes (ink vehicles) may comprise, among other components, e.g. high boiling distillates and/or vegetable oils, high wetting alkyd resins plus highly structured alkyd resins and vegetable resins, and mixtures thereof; further monomers/oligomers/polymers that can be cured by UV-radiation can also be used.

The high boiling distillates may be so-called mineral oil solvents which comprise aliphatic or aromatic hydrocarbon distillate fractions of boiling points of from 100 to 350° C., preferably of from 180 to 300° C., or vegetable oils.

The vegetable oils for use in the printing ink vehicles of the invention are the commonly available vegetable triglycerides in which the fatty acid moieties have a chain length of about 12 to 24 carbon atoms, preferably of 18 to 22 carbon atoms. Of particular interest are those which have a substantial proportion of diunsaturated linoleic fatty acid and triunsaturated linolenic fatty acid moieties, e.g. soybean, coconut, cottonseed, linseed, safflower, sunflower, corn, sesame, rapeseed and peanut oil or mixtures thereof.

Though the aforementioned oils can be employed in the crude state as originally expressed from the seed material, there are advantages to subjecting them to certain preliminary processing steps. For example, alkali refining removes the gums and phospholipids which may interfere with the properties of the vehicles and the ultimate ink formulations. Alkali refining also removes free fatty acids, which tend to reduce hydrophobicity properties in ink formulations.

The hydrocarbon distillate fractions are preferred, but vegetable oils are also important

Examples of the resins include long-oil alkyd resins, medium-oil alkyd resins, short-oil alkyd resins, phenol-modified alkyd resins, styrenated alkyd resins, aminoalkyl resins, oil-free alkyd resins, thermosetting acrylic resins, UV-curing resins, acryl laquer resins, acrylpolyol resins, polyester resins, epoxy resins, methylated or butylated melamine resins, vinylacetate copolymers, styrene or styrene-acrylic resins, styrene-diene copolymers, polyurethane resins, rosin (abietic acid), rosin (acid) salts, such as alkali metal salts (sodium, potassium), and modified rosins such as rosin (acid) metal resinates (copper, zinc, magnesium resinates), rosin esters, such as maleinized rosin, pentaerythritol rosin or rosin-modified phenolic resins, and further vegetable oil based rosin esters, such as soybean or tall oil esters (methyl, butyl), and further hydrogenated rosins, disproportonated rosins, dimerised, polymerised and part-polymerised rosins (rosins, cross-linked with e.g. formaldehyde), or mixtures thereof. These compounds and their use in printing compositions are well known in the art. They are not limitative.

Examples for monomers that can be cured by UV-radiation are, but not exclusively, acrylate monomers, such as 1,4-butanediolacrylate, propoxylated glycerol triacrylate and pentaerythritol triacrylate.

UV-curable monomers can be considered as an ink solvent for the solution of the solvent dyes. Following UV-curing, it can then be considered that the solvent dye remains dissolved or dispersed in the cured resin. As the point of discrimination between ink-solvent and ink-resin activity is flowing, for example partially UV-cured oligomers could be classed as both a solvent and a resin.

Further details for lithographic printing inks (also known as off-set inks, oil-based inks, distillate based inks or vegetable oil based ink) can be found in “The Printing Ink Manual,” 5^{th} edition, edited by R. H. Leach. and R. J. Pierce, Blueprint (Chapman and Hall), chapter 6, p. 342-452 (1993).

The pigment/solvent dye combinations (mixtures) can be prepared by mixing (grinding) the two components in a conventional manner in solid or liquid state. In the latter case, the solvent dye is predissolved or dispersed in an organic solvent which may be aliphatic, alicyclic, and aromatic hydrocarbons, halogenated hydrocarbons, esters, ketones, and alcohols.

The oil based printing inks for lithographic printing systems can be prepared by incorporating the pigment into the printing ink varnish by a variety of shear inducing methods, such as mixing, bead-milling, triple-roll milling, kneading and extrusion; alternatively, heat-inducing methods can also be used.

Examples of typical methodology are triple roll mill, horizontal or vertical bead mill, cobra mill, Z-blade mixer or kneader, single, twin or triple screw extruder and also a Muller glass plate dispersion apparatus.

The dyestuff can be dissolved into the varnish by any method allowing the application of heat. This heat can be deliberately applied from an external source. For example, laboratory scale incorporation of the dye can be carried out on a hot-plate or water-jacket heated bead-mill. During the incorporation process, agitation is an advantage though high shear is not essential.

Alternatively, the heat can originate from the shearing action and motility of a viscous substrate. For example, the industrial scale bead-milling process on a lithographic varnish often produces heat. This heat production is often greater during the attempted dispersion of pigment as the viscosity of the pigment/varnish mixture is higher.

If the pigment incorporation method does not produce heat, the solvent dye is best incorporated by pre-dissolving in a sample of the varnish medium, or one or more of the varnish components or solvents, by the addition of heat.

The preferred method of incorporation would be extrusion. In an ink vehicle (or molten ink vehicle resin) passed through such as apparatus, dispersion of the pigment (by high shear) and solution of the dye (by heat generation) can be achieved either simultaneously or sequentially.

The pigment may be applied as either a damp press-cake, dry lump, granule or powder. For extrusion, the use of granules in currently preferred due to the lower dusting of this pigment form. The solvent dye could similarly be applied as a damp cake, dry lump, granule or powder.

Furthermore, the varnish can be premixed or coloured with the solvent dye and then added to an aqueous pigment slurry. Alternatively, the varnish can be added to an aqueous slurry of the solvent dye or a mixed slurry of the pigment and solvent dye. The obtained pigment/solvent dye combinations can then be isolated by filtration and optionally drying; they are one basis for the inventive lithographic printing ink-compositions.

Alternatively, the solvent dye (as solid or solution in an organic solvent as mentioned) may also be incorporated by late addition to the finished (pigment) printing ink followed by heating, if necessary to complete solution.

The inventive oil-based lithographic printing ink may in addition comprise customary additives known to those skilled in the art.

Typical additives include drying enhancers, drying inhibitors, non-coloured extenders, fillers, opacifiers, antioxidants, waxes, oils, surfactants, rheology modifiers, wetting agents, dispersion stabilizers, strike-through inhibitors and anti-foaming agents; further adherence promoters, cross-linking agents, plasticisers, photoinitiators, light stabilizers, deodorants, biocides, laking agents and chelating agents.

Such additives are usually used in amounts of from 0 to 10% by weight, particularly from 0 to 5% by weight, and preferably from 0.01 to 2% by weight, based on the total weight of the lithographic printing ink composition.

The inventive printing ink can be used in lithographic printing processes on a lithographic printing press whereby it is passed from a reservoir by means of a roller duct system to the flat substrate to be printed (inking plate). This plate is pre-treated with aqueous fount solution often containing alcoholic components to aid the lithographic process. The printing processes are further objects of the present invention.

The inventive printing inks lead to an overall good printing performance and produce prints of unexpectedly increased colour strength (compared with an ink based on pigment alone), further improved gloss and transparency in all types of lithographic printing inks know in the art, e.g. heatset, sheetfed, coldset or uv-curing printing inks.

The present invention is hereinafter further described with reference to particular examples thereof. It will be appreciated that these examples are presented for illustrative purposes and should not be construed as a limitation of the scope of the invention as herein described.

In the following examples, quantities are expressed as part by weight or percent by weight, if not otherwise indicated. The temperatures are indicated in degrees centigrade.

### EXAMPLES

The following table shows a selection of red solvent dyes (of the phenylazophenylazo-beta-naphthol class) to be used in the present invention:

TABLE 1

| | |
|---|---|
| | (1) |
| 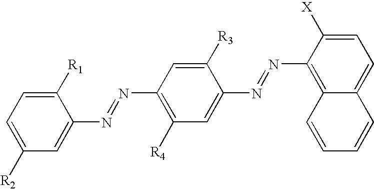 | |

| R₁ | R₂ | R₃ | R₄ | X | DYE SYNONYMS |
|---|---|---|---|---|---|
| H | H | H | H | OH | C.I. Solvent Red 23 |
| | | | | | Sudan III |
| | | | | | 1-((4-phenylazo)phenyl)azo-2-naphthol |
| CH₃ | H | CH₃ | H | OH | C.I. Solvent Red 24 |
| | | | | | Sudan IV |
| | | | | | 1-(4-o-tolylazo-o-tolylazo)-2-naphthol |
| CH₃ | H | CH₃ | CH₃ | OH | C.I. Solvent Red 26 |
| | | | | | Oil Red EGN |
| | | | | | 1-((2,5-dimethyl-4-((2- |
| | | | | | methylphenyl)azo)phenyl)azo)-2-naphthol |
| CH₃ | CH₃ | CH₃ | CH₃ | OH | C.I. Solvent Red 27 |
| | | | | | Oil Red O |
| | | | | | 1-((4-(dimethylphenyl)azo)dimethylphenyl)azo)-2- |
| | | | | | naphthol |
| H | CH₃ | H | CH₃ | OH | C.I. Solvent Red 25 |
| | | | | | Sudan Red B |
| | | | | | 1-((3-methyl-4-((3-methylphenyl)azo)phenyl)azo)- |
| | | | | | 2-naphthol |
| H | H | H | H | NHCH₂CH₃ | C.I. Solvent Red 19 |
| | | | | | Sudan Red 7B |
| | | | | | N-ethyl-((4-(phenylazo)phenyl)azo)-2- |
| | | | | | naphthylamine |

Further dyes can be found in “The Colour Index published by The Society of Dyers and Colourists”. C.I. numbers for these red dyes are 26000-26150. The structure of a further applicable red dye (C.I. Solvent Red 29) found within this C.I. number selection is shown below (Formula 2).

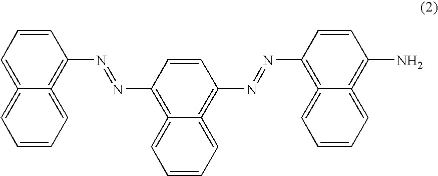

### Example 1

### Ink A

24 g of 1-((4-((dimethylphenyl)azo)dimethylphenyl)azo)2-naphthol is incorporated into 141.75 g of a commercial heat-set varnish composition by high shear bead-milling which leads to the composition experiencing a temperature of 80° C. for a period of 15 minutes.

### Ink B

27 g of a C.I. Pigment Red 57:1 composition tailored for heat-set use is incorporated into 141.75 g of a commercial heat-set varnish by an identical method to Ink A.

### Ink C

23 g of 1-((2,5-dimethyl-4-((2-methylphenyl)azo)phenyl)azo)-2-naphthol is incorporated into 141.75 g of a commercial heat-set varnish by an identical method to Ink A.

### Ink Blends

Blends of inks A and B plus also blends of inks B and C are prepared by 2 series of 25 revolutions per minute on a Muller glass plate dispersion apparatus. The instrumental strength at 510-550 nm for each blend is compared against the standard pigment-only ink B (which is given the figure of 100%) by Prufbau printing. Key Prufbau prints are also compared visually and assigned strength figures against standard in 5% increments.

TABLE 2

| | | | Instrumental | Visual |
|---|---|---|---|---|
| Ink A | Ink B | Ink C | Strength | Strength |
| — | 100 | — | 100% | 100% |
| 10 | 90 | — | 114% | 110-115% |
| 20 | 80 | — | 116% | 115% |
| 30 | 70 | — | 112% | — |
| 50 | 50 | — | 110% | — |
| 70 | 30 | — | 105% | — |
| 100 | — | — | 94% | — |
| — | 90 | 10 | 111% | 110% |
| — | 80 | 20 | 121% | 120% |
| — | 70 | 30 | 123% | 125% |
| — | 50 | 50 | 119% | — |
| — | 30 | 70 | 110% | — |
| — | 10 | 90 | 104% | — |
| — | — | 100 | 97% | — |

### Pigment/Solvent Dye Blends—Additional Benefits

As examples of the additional benefits achievable by the incorporation of even relatively small amounts of dyestuff, prints from the 90/10 and 80/20 ink B/ink A blends show slightly improved gloss and transparency over ink B alone.

Similar effects are found from the 90/10 and 80/20 ink B/ink C blends. Furthermore, the 70/30 ink B/ink C blend displays a significant improvement in both gloss and transparency over ink B alone.

1. A lithographic printing composition, comprising an organic pigment, an organic dyestuff soluble in an organic solvent (solvent dye), a printing ink varnish (ink vehicle) and a solvent, the printing ink varnish being mixed or coloured with the solvent dye either prior to or during pigment dispersion.

2. The composition as claimed in claim 1, wherein said organic dyestuff is a solvent dye selected from the group consisting of C.I. Solvent Red 1, 19, 23, 24, 25, 26, 27, 29, 49, 52, 111, C.I. Solvent Blue 14, 35, 36, 59, 78, C.I. Solvent Yellow 7, 14, 33, 72, 94, 114, C.I. Solvent Orange 1, 2, 7, and mixtures thereof.

3. The composition according to claim 1, characterized in that said organic pigment is a disazo or a naphthol pigment.

4. The composition according to claim 1, wherein the pigment and solvent dye are present in a pigment/solvent dye ratio of from 95/5 to 30/70.

5. The composition according to claim 4, wherein the pigment/solvent dye ratio is from 95/5 to 65/35.

6. The composition according to claim 1 which comprises a mixture of solvent dyes and/or a mixture of organic pigments.

7. (canceled)

8. A composition according to claim 1 which is a pigmented lithographic printing ink which comprises an organic pigment and a solvent dye in a total amount of 0.1-70%, by weight based on the total weight of the pigmented lithographic printing ink, and the remainder being printing ink varnishes, solvents and other customary additives.

9. The pigmented lithographic printing ink according to claim 8, which is a ready-to-use lithographic printing ink and which comprises the organic pigment and the solvent dye in a total amount of 2 to 20%, by weight based on the total weight of the pigmented lithographic printing ink.

10. A pigmented lithographic printing ink according to claim 8, which is an ink concentrate and which comprises the organic pigment and the solvent dye in a total amount of 20 to 70%, by weight based on the total weight of the pigmented lithographic printing ink.

11. The pigmented lithographic printing ink according to claim 8 which comprises as printing ink varnishes blends of high boiling distillates and/or vegetable oils, high wetting alkyd resins, highly structured alkyd resins, vegetable resins, mixtures thereof; or monomers/oligomers/polymers that can be cured by UV-radiation.

12. A process for the preparation of pigmented lithographic printing inks according to claim 8 which comprises incorporating either the pigment/solvent dye composition or the pigment and the solvent dye separately into a printing ink varnish, or one of its components, by shear rate- or heat-inducing methods, and optionally combining the pigment/solvent dye loaded components with the other components of the varnish.

13. (canceled)

14. A process for the preparation of pigmented lithographic printing inks according to claim 8 which comprises incorporating the solvent dye as solid or solution in an organic solvent to the finished printing ink, optionally followed by heating.

15. A process for the preparation of pigmented lithographic printing inks according to claim 8 which comprises the flushing of presscakes of pigment or pigment/dye mixtures into a varnish medium or a pre-dyed varnish medium.

16. A lithographic printing process which comprises printing a flat substrate with the pigmented lithographic printing inks according to claim 8.

17. A composition according to claim 1 which is a lithographic printing ink colourant, wherein the organic pigment is coated with a printing ink varnish (ink vehicle).

18. The colourant according to claim 17, which comprises the organic pigment and the solvent dye in a total amount of 60 to 95%, by weight, and 40 to 5%, by weight, of printing ink varnishes (ink vehicles), solvent and other customary additives.

19. The colourant according to claim 17, wherein the pigment and solvent dye are present in a pigment/solvent dye ratio of from 95/5 to 30/70.

20. The colourant according to claim 17, wherein the pigment/solvent dye ratio is from 95/5 to 65/35.

21. A pigmented lithographic printing ink, which comprises the colourant according to claim 17.

22. A process for the preparation of the lithographic printing ink colourants according to claim 17 which comprises
(a) incorporating the printing ink varnish, which is premixed or coloured with the solvent dye, into an aqueous slurry of the organic pigment, isolating, and optionally drying it, or
(b) adding the printing ink varnish to an aqueous slurry of the solvent dye and then combining it with an aqueous slurry of the organic pigment, isolating, and optionally drying it, or
(c) adding the printing ink varnish to an aqueous slurry of a solvent dye/organic pigment combination, isolating, and optionally drying it.
